(19) United States
(12) Patent Application Publication
(10) Pub. No.: US 2025/0371080 A1
(43) Pub. Date: Dec. 4, 2025

(54) GUIDING MULTIPLE MODELS WITH A LARGE LANGUAGE MODEL

(71) Applicant: NEC Laboratories America, Inc., Princeton, NJ (US)

(72) Inventors: Iain Melvin, Princeton, NJ (US); Christopher Malon, Fort Lee, NJ (US)

(21) Appl. No.: 19/219,090

(22) Filed: May 27, 2025

Related U.S. Application Data
(60) Provisional application No. 63/652,298, filed on May 28, 2024.

(51) Int. Cl. G06F 16/93; G06F 21/62

(52) U.S. Cl. CPC G06F 16/93; G06F 21/6227

(57) ABSTRACT

Systems and methods for guiding multiple models with a large language model. An instruction code can be generated for a very large language model (VLLM) to generate a general guidance to guide Al models that answer reasoning questions for query documents. The instruction code can be updated with domain-specific information from reference materials to generate, with the VLLM, a reasoned answer for reasoning questions about the query documents generated based on the general guidance. The reasoned answers can be processed into the general guidance with the VLLM. The reasoning question iteratively applied to the query documents can be answered using the general guidance with the Al models to perform downstream tasks.

### RELATED APPLICATION INFORMATION

This application claims priority to U.S. Provisional App. No. 63/652,298, filed on May 28, 2024, incorporated herein by reference in its entirety.

### BACKGROUND

### Technical Field

The present invention relates to natural language processing using artificial intelligence (AI) models, and more particularly to guiding multiple models with a large language model.

### Description of the Related Art

AI models have progressed over the years where they can generate human-like inferences regarding documents. However, the inferences are dependent on the quality of prompts and the domain knowledge of the AI models. Trying to generate inferences using an immature AI model may generate incorrect data using immature reasoning.

### SUMMARY

According to an aspect of the present invention, a computer-implemented method is provided, including, generating an instruction code for a very large language model (VLLM) to generate a general guidance to guide AI models that answer reasoning questions for query documents, updating the instruction code with domain-specific information from reference materials to generate, with the VLLM, a reasoned answer for reasoning questions about the query documents generated based on the general guidance, processing the reasoned answers into the general guidance with the VLLM, and answering, with the AI models, the reasoning question iteratively applied to the query documents using the general guidance to perform downstream tasks.

According to another aspect of the present invention, a system is provided, including, a memory device, one or more processor devices operatively coupled with the memory device to perform operations, generating an instruction code for a very large language model (VLLM) to generate a general guidance to guide AI models that answer reasoning questions for query documents, updating the instruction code with domain-specific information from reference materials to generate, with the VLLM, a reasoned answer for reasoning questions about the query documents generated based on the general guidance, processing the reasoned answers into the general guidance with the VLLM, and answering, with the AI models, the reasoning question iteratively applied to the query documents using the general guidance to perform downstream tasks.

According to yet another aspect of the present invention, a non-transitory computer program product is provided including a computer-readable storage medium having a program code, wherein the program code when executed on a computer causes the computer to perform operations including, generating an instruction code for a very large language model (VLLM) to generate a general guidance to guide AI models that answer reasoning questions for query documents, updating the instruction code with domain-specific information from reference materials to generate, with the VLLM, a reasoned answer for reasoning questions about the query documents generated based on the general guidance, processing the reasoned answers into the general guidance with the VLLM, and answering, with the AI models, the reasoning question iteratively applied to the query documents using the general guidance to perform downstream tasks.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a flow diagram showing a high-level overview of a method for guiding multiple models with a large language model, in accordance with an embodiment of the present invention;

FIG. 2 is a block diagram showing a method of enforcing privacy of query documents, in accordance with an embodiment of the present invention;

FIG. 3 is a block diagram showing a system implementing practical applications of guiding multiple models with a large language model, in accordance with an embodiment of the present invention;

FIG. 4 is a block diagram showing a visualization view after implementing guiding multiple models with a large language model, in accordance with an embodiment of the present invention;

FIG. 5 is a block diagram showing an embodiment of a visualization view for the downstream tasks, in accordance with an embodiment of the present invention;

FIG. 6 is a block diagram showing a computer system for guiding multiple models with a large language model, in accordance with an embodiment of the present invention; and

FIG. 7 is a block diagram showing hardware and software components of the computing device that implements guiding multiple models with a large language model, in accordance with an embodiment of the present invention.

### DETAILED DESCRIPTION OF PREFERRED EMBODIMENTS

In accordance with embodiments of the present invention, systems and methods are provided for guiding multiple models with a large language model.

In an embodiment, an instruction code can be generated for a very large language model (VLLM) to generate a general guidance to guide AI models that answer reasoning questions for query documents. The instruction code can be updated with domain-specific information from reference materials to generate, with the VLLM, a reasoned answer for reasoning questions about the query documents generated based on the general guidance. The reasoned answers can be processed into a general guidance with the VLLM. The reasoning question iteratively applied to the query documents can be answered using the general guidance with the AI models to perform downstream tasks.

Insights can be generated from hundreds or thousands of documents including textual, audio, video data using AI models. Insights can reflect the understanding of machine learning models regarding domain-specific queries. The documents could be anything, e.g., company reports, news stories, recipes for chemical processes, etc., having similar structure about similar things.

Very Large Language Models (VLLMs) can be used to answer generic questions over a single document. VLLMs can have human-like closed book knowledge, and can reason well in their responses. However, they are expensive to run, slow, and can include privacy issues as processing of the documents can occur through a public service application programming interface (API) having unverified privacy practices.

Smaller language models can be utilized locally which enables fast, private and cheap processing of the documents. However, they are less capable then the VLLMs, and can make frequent errors in factual knowledge and reasoning.

Additionally, using LLM models can generate incomprehensible text, which is arduous for the user to read. As such, the format of the outputs of the models can be updated in a format that is easy for the end user to process.

To resolve these issues, the present embodiments can utilize multiple artificial intelligence (AI) models such as Large Language Models in concert to give answers to queries regarding domain information within the documents and preserve the privacy of the query documents. A VLLM can be utilized to guide the multiple AI models. To do so, a two-step process can be employed to instruct the VLLM to provide simple questions as guidance to the smaller AI models. This involves a “self-reflection” step where the VLLM reflects on the answer it gave and rephrases the answer in the form of simple questions that will help the small LLM in its task. The results can be visualized which enables the user to select different dimensions (answers) for embedding/axis/visual. By doing so, the present embodiments increase the accuracy of the smaller AI models by utilizing iterative natural language queries regarding the query documents, including potential candidates for downstream tasks, while ensuring the privacy of the query documents.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

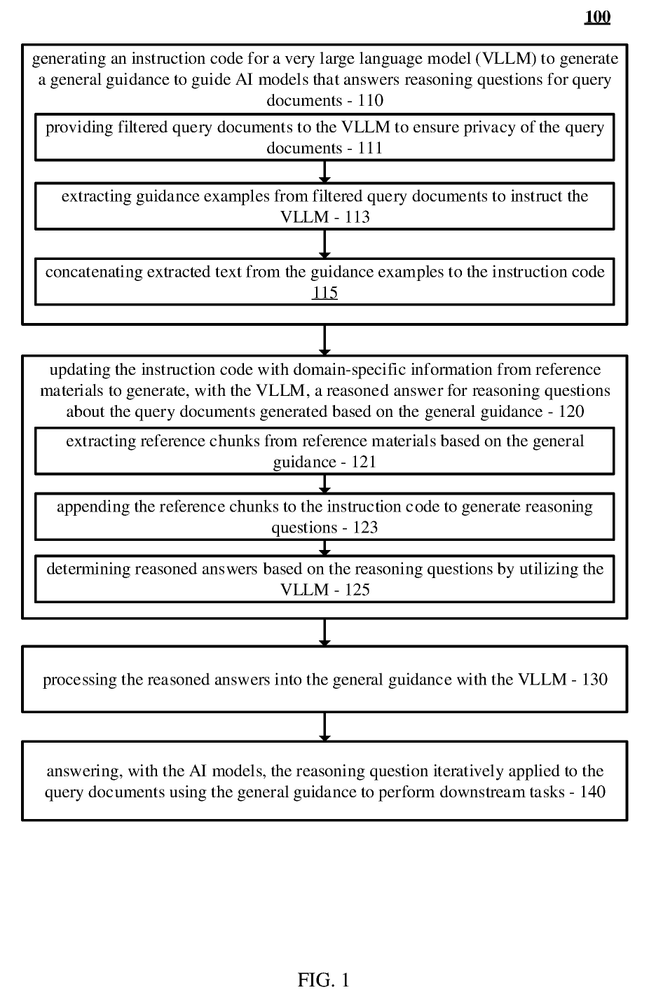

Referring now in detail to the figures in which like numerals represent the same or similar elements and initially to FIG. 1, a flow diagram showing a high-level overview of a method for guiding multiple models with a large language model, in accordance with an embodiment of the present invention.

In an embodiment, an instruction code can be generated for a very large language model (VLLM) to generate a general guidance to guide AI models that answer reasoning questions for query documents. The instruction code can be updated with domain-specific information from reference materials to generate, with the VLLM, a reasoned answer for reasoning questions about the query documents generated based on the general guidance. The reasoned answers can be processed into a general guidance with the VLLM. The reasoning question iteratively applied to the query documents can be answered using the general guidance with the AI models to perform downstream tasks.

In block 110, an instruction code can be generated for a very large language model (VLLM) to generate a general guidance to guide AI models that answer reasoning questions for query documents.

The general guidance can include the response from the VLLM to guide AI models to answer reasoning questions. The general guidance allows processing documents to determine domain-specific information from the query documents in a reasonable time and cost while preserving privacy. The general guidance can include information about what the AI models can perform to answer domain-specific questions rather than the VLLM answer the domain-specific question. The general guidance can be based on guidance heuristics.

The very large language model (VLLM) is a very large (e.g., using at least billions of parameters), accurate deep learning model trained for natural language processing, such as GPT™, Qwen™, LLaMa™, etc. The AI models can be smaller (e.g., using at least millions of parameters) large language models compared to VLLM, that can be trained for domain-specific tasks such as natural language processing, generalization, summarization, etc.

The query documents can be a set of text files to be processed. These could be text documents containing words, audio, video, etc.

The reasoning question can include common questions about how to process the query documents. For example, the reasoning question can include queries about the subjects to search for in reference materials, information to focus on, the type of reference materials to look for, etc.

In block 111, query documents can be filtered to ensure privacy of the query documents based on determined privacy classifications to obtain filtered query documents.

The privacy classification of the query documents can be determined based on the sensitivity of the data within the query documents. The sensitivity can be predetermined and saved in a database. For example, the sensitivity of the data can be high when the data contains highly sensitive data such as social security numbers, trade secrets, etc. The sensitivity of the data can be low when the data contains public records (e.g., news, publications, etc.) or data that has been flagged without privacy issues (e.g., documents already in the public domain). To determine the sensitivity of the data, a sensitivity filter can be utilized which can employ natural language processing and learned domain knowledge to process the data within the query documents and compare them to the saved sensitivity. In another embodiment, the status of the VLLM can be utilized to filter the query documents. For example, if the VLLM is a public service in another organization, documents having low sensitivity can be transmitted to the VLLM.

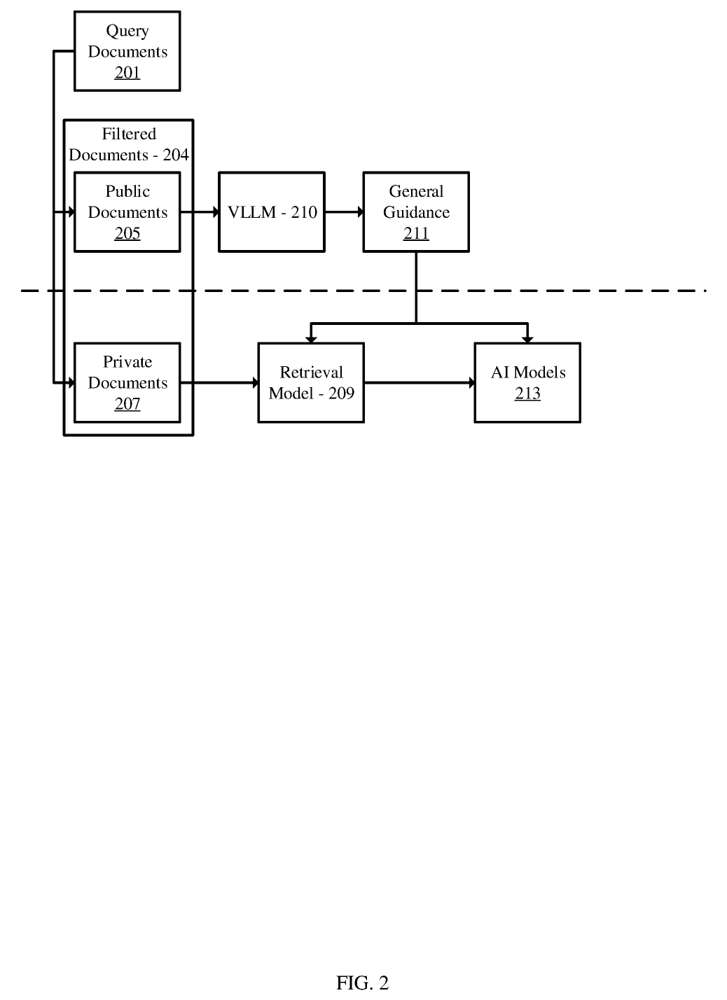

Referring now to FIG. 2, a block diagram showing a method of enforcing privacy of query documents, in accordance with an embodiment of the present invention.

The query documents 201 can be pre-filtered to obtain public documents 205 and private documents 207. The public documents 205 can be processed by the VLLM 210 to generate general guidance 211. The private documents 207 can be processed by the retrieval model 209 to extract domain information from the private documents 207. The general guidance 211 can be utilized by the retrieval model 209 and the AI models 213 to answer queries regarding the domain information. The retrieval model 209 can include a machine learning model that encodes text and queries to a vector representation and returns text in the neighborhood of the query.

Referring back now to FIG. 1. In block 113, guidance examples can be extracted from filtered query documents to instruct the VLLM.

The guidance examples can refer to snippets from the query documents that can be used to obtain guidance heuristics for the VLLM. The guidance heuristics can refer to rules that the VLLM can follow to guide itself through a process. For example, a guidance example showing polymer A having constituent elements B and C can be sent to the VLLM. The guidance heuristics from the guidance example can include prioritizing the constituent elements B and C, determining the chemical composition of constituent elements, etc. The filtering module 203 can extract the guidance examples.

In block 115, extracted text from the guidance examples can be concatenated to the instruction code.

In an embodiment, the extracted text from the guidance examples can be concatenated iteratively to the instruction code until a predetermined threshold is met. The predetermined threshold can be determined from the number of query documents, the number of guidance examples to be sent, etc.

The instruction code can include text instructing the VLLM, and accompanying input data that can follow an instruction template. For example, the instruction code can include “We will be asking a question about a similar document, which will be provided in the same format, but contain different properties and values. Don't answer the question, but tell me how you would use the information provided to give your answer if I was to provide a document in a similar format. I will also be providing some reference material. What kinds of things would you look for in the reference material to help you answer the question?".

In block 120, the instruction code can be updated with domain-specific information from reference materials to generate, with the VLLM, a reasoned answer for reasoning questions about the query documents generated based on the general guidance.

In block 121, reference chunks can be extracted from reference materials based on the general guidance.

The reference chunks can include fragments of text from the reference material that might be useful to the query synthesis LLM in answering the user queries. The reference chunk can include domain-specific information.

The reference material can include documents that may be related to the user queries and the query documents. For example, in an application for material science, the reference material can include published journal papers about potential materials or material candidates or text books related to the queries and query documents likely to be posted to the application

To extract the reference chunks from the reference materials, a retrieval module can be employed. The retrieval module can retrieve chunks of text from a large reference corpora based on similarity with a user query. To extract the reference chunks, the retrieval module can utilize Retrieval Augmented Generation (RAG) that uses a vector-index to retrieve text fragments. The retrieval module can utilize the general guidance as input to perform the extraction.

In block 123, the reference chunks can be appended to the instruction code to generate reasoning questions.

The reasoning questions can include queries about the reference chunks and the query documents. For example, in a material exploration query, query documents can include information about material candidates, and the reference materials can include domain-specific information about the material candidates such as physical attributes (e.g., boiling point, density, etc.), applications (e.g., usage in semiconductor fabrication, etc.). The reasoning questions can include queries about the physical attributes of the material candidates, such as “Is the polymer biodegradable?”.

In block 125, reasoned answers can be determined based on the reasoning questions by utilizing the VLLM.

The reasoned answers can be utilized to suggest and generate other reasoning questions to be utilized to answer user queries about other query documents, including other candidates for downstream tasks. The reasoned answer can be generated by the VLLM by utilizing the reasoning questions. The reasoned answers can include text that provides a rational explanation about the reasoning questions. In the example above, the reasoned answer can include “the polymer is biodegradable because it produces X amount of carbon dioxide when microorganisms digest a sample of the polymer.” The user queries can include text that a user provides to ask about the query documents. The user queries can include an expected format of the answer such as a Boolean “yes or no” response or a numerical answer (e.g. a temperature).

In block 130, the reasoned answers can be processed into the general guidance with the VLLM.

The general guidance can be derived from the reasoning process used by the VLLM to generate the reasoned answers. The general guidance can be utilized and applied iteratively to other query documents based on the user queries.

The VLLM can be utilized to convert the reasoned answers into question format through a query instruction code. For example, for the materials exploration example, the query instruction code can include “Now take each reason in that answer and ask whether that factor applies to a new polymer. Make a list of simple questions like, Is the new polymer derived from cellulose?". The query instruction code can then be processed into the general guidance. To measure the speed and cost of the query-answering process, a number of queries multiplied by a number of entities can be computed. Since the VLLM is expensive and slow, this can lead to very long waits for a complete set of answers and high cost. To overcome this, smaller AI models can perform the bulk of this work faster with lower costs.

In block 140, The reasoning question iteratively applied to the query documents can be answered using the general guidance with the AI models to perform downstream tasks.

The general guidance can be utilized and applied iteratively to other query documents based on the user queries. Because the general guidance is in an easily understandable format, the AI models can generate answers to the general guidance with lower cost but higher speed than the VLLM. The answers can be set into the expected format as determined in the general guidance.

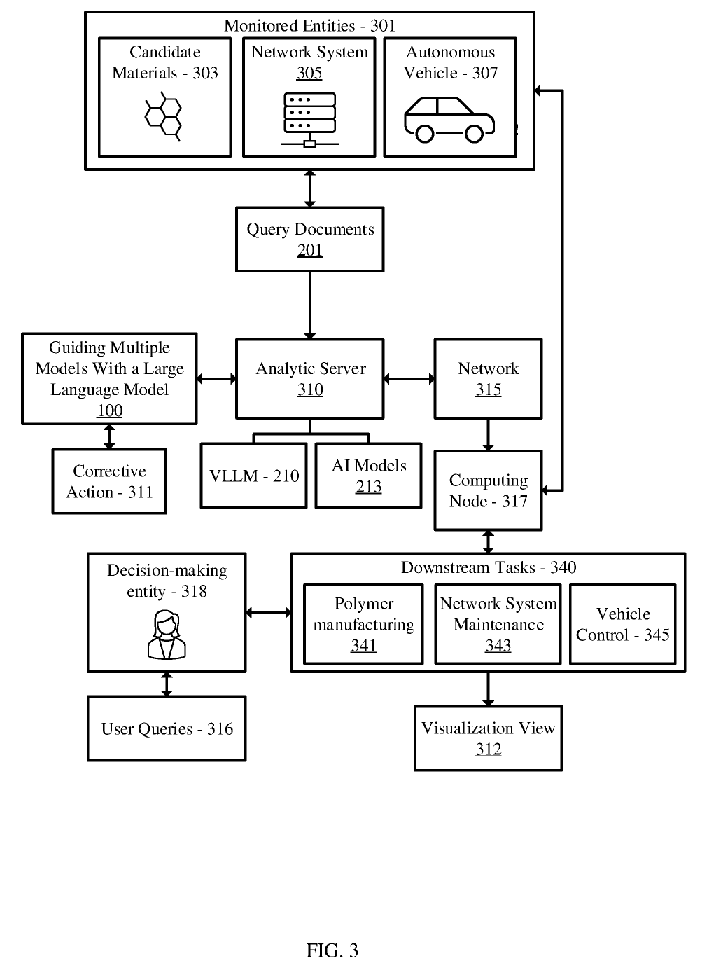

In another embodiment, the appropriate AI models can be determined that can optimally answer the general guidance based on domain knowledge. The AI models can be tested to determine accuracy scores based on domain knowledge and the AI models having the highest accuracy scores can be selected as appropriate AI models. The answers can then be visualized and utilized for performing downstream tasks. The downstream tasks is shown in more detail in FIG. 3.

Referring now to FIG. 3, a block diagram showing a system implementing practical applications of guiding multiple models with a large language model, in accordance with an embodiment of the present invention.

In system 300, monitored entities 301 can include candidate materials 303, network system 305, and autonomous vehicle 307. The monitored entities 301 can generate query documents 309. The query documents 309 can be transmitted to an analytic server 310 that can implement guiding multiple models with a large language model 100. The analytic server 310 can communicate with a very large language model (VLLM) 312 and artificial intelligence (AI) models 313.

System 300 can be utilized to perform downstream tasks 340 based on the query documents 309 and user queries 316 from a decision-making entity 318. The downstream tasks 340 can include polymer manufacturing 341, network system maintenance 343, and vehicle control 345. The analytic server 310 can generate a corrective action 311 for the downstream tasks 340 to be sent to computing nodes 317 for the downstream tasks 340 through a network 315. The computing node 317 can implement a visualization view 312.

In polymer manufacturing 341, query documents 309 related to candidate materials 303 can be processed to answer user queries 316 and determine candidate materials to manufacture a polymer with desired properties. The user queries 316 can be relevant to how new polymers with desired properties (e.g., molecular weight, biodegradability, etc.) can be manufactured. A corrective action 311 can be generated by the analytic server 310 which can include the answer to the user queries 316 to manufacture the polymer. Based on the corrective action 311, a polymer manufacturing device can be utilized to manufacture the polymer using candidate materials determined to have desired properties.

In network system maintenance 343, query documents 309 (e.g., system logs, test cases, etc.) related to the network system 305 can be processed to answer user queries 316. The user queries 316 can be relevant to how to properly maintain the network system 305 based on the query documents 309. A corrective action 311 can be generated by the analytic server 310 which can include the answer to the user queries 316 to maintain the network system 305. Based on the corrective action 311 (e.g., adding bandwidth, blocking packets from an identified internet protocol (IP) address to resolve malicious attacks, etc.) the network system can be autonomously maintained.

In vehicle control 345, query documents 309 (e.g., vehicle part status, traffic scene,.) related to the autonomous vehicle 307 can be processed to answer user queries 316. The user queries 316 can be relevant to how to control the autonomous vehicle 307 given its environment based on the query documents 309. A corrective action 311 can be generated by the analytic server 310 which can include the answer to the user queries 316 to control the proper performance of the autonomous vehicle 307. Based on the corrective action 311 (e.g., stopping, speeding up, changing direction, etc.) the autonomous vehicle 307 can be autonomously controlled using appropriate control devices (e.g., advanced driver assistance systems, braking device, accelerator device, cooling device, etc.) within the autonomous vehicle. Other downstream tasks and practical applications are contemplated.

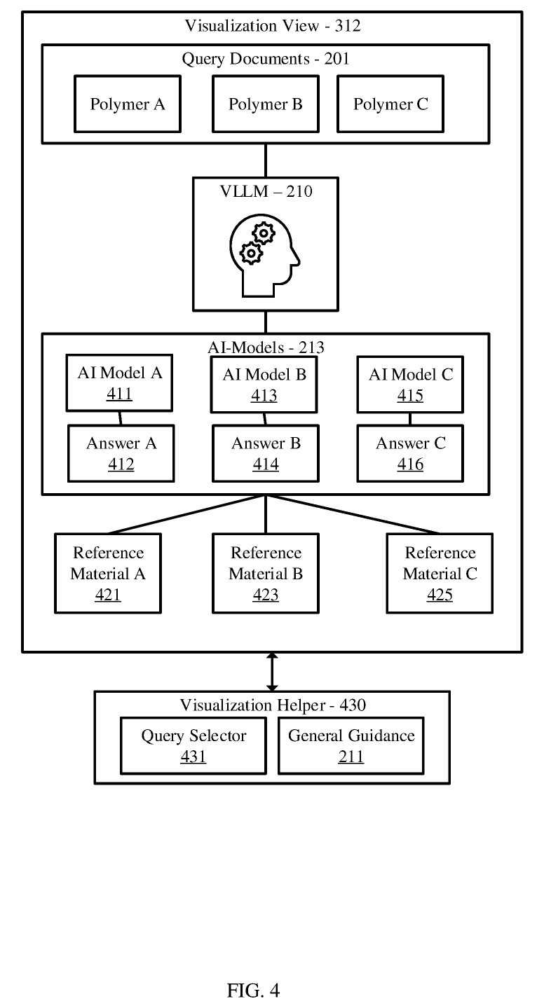

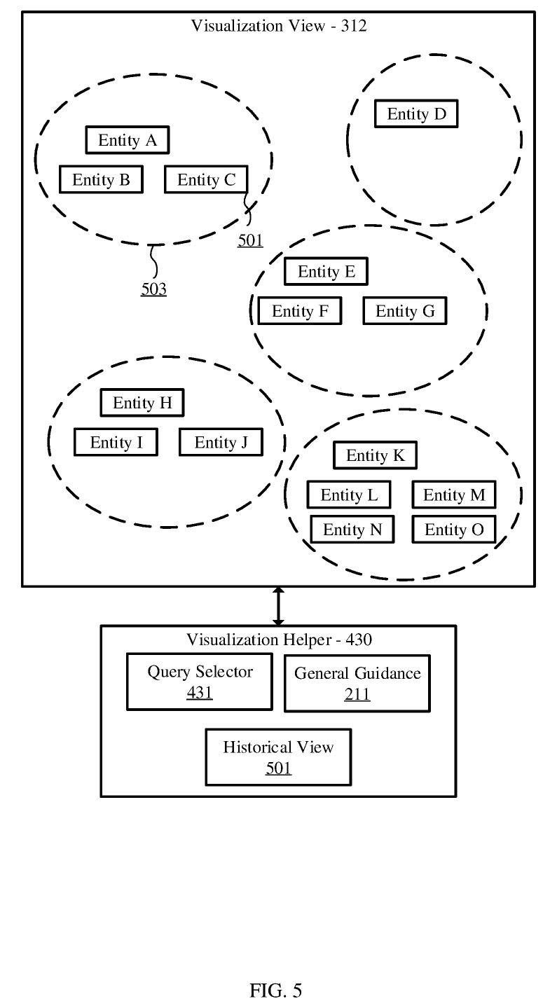

The visualization view 312 can show a historical view of how the system 300 performed the downstream tasks 340. More details regarding the visualization view 312 is shown in FIGS. 4 and 5.

Referring now to FIG. 4, a block diagram showing a visualization view after implementing guiding multiple models with a large language model, in accordance with an embodiment of the present invention.

The guiding process can be visualized using the visualization application. The visualization application can include a view where relations and trends between the answers can be shown by rendering the set of query documents on axes.

Axes can be generated by using machine learning (ML) “embedding” methods that map N dimensions to 2 dimensions (x,y) where N is the number of user queries selected to be represented. This produces plots where similar documents are grouped together depending on the answers to the selected queries. Axes can be set directly according to the numerical outputs of the queries. For example, by choosing “year of company founding” on the x axis and “company profits in 2024”, which can both be user queries over a set of company documents, an original plot can be generated with no user interaction other that the posing of the original queries over the original documents. Raw input documents can directly correspond to plots that generate insights. When queries have text rather than numerical answers, the answers’ vector embeddings (through a VLLM such as BERT™) can be used to position them in a higher-than-two-dimensional space. Methods such as t-distributed stochastic neighbor embedding (t-SNE) or uniform manifold approximation and projection (UMAP) can be used to utilize cosine similarities between points in the high-dimensional space to embed the points in a two-dimensional display.

The reference materials 421, 423, 425 can be utilized by the AI models 313 (e.g., 411, 413, 415) to generate corresponding answers 412, 414, 416. The lines can correspond to information that was sent to the VLLM 210 and can include the textual result from the guidance request. The general guidance 211 can include a list of things the AI models 313 can identify when answering the question.

The visualization helper 430 can include a query selector 431 and a view of the general guidance 211. The visualization view 312 and the general guidance 211 can be updated based on the selected query in the query selector 431.

Referring now to FIG. 5, a block diagram showing an embodiment of a visualization view for the downstream tasks, in accordance with an embodiment of the present invention.

The answers from the AI Models 213 can be visualized for downstream tasks. For example, in polymer manufacturing, visualizations from the answers to questions posed of the set of polymers. The list of previously answered questions can also be shown through the historical view 501. The 2 dimensional layout (positions) of the polymers can be determined by a layout algorithm such as uniform manifold approximation and projection (UMAP), which takes an N-dimensional representation of each entity (polymer) and performs an optimization that produces a 2 dimensional set of positions that effectively tries to preserve spatial neighborhoods in the high N-dimensional space in the lower dimensional space. The N-dimensional space to reduce is selectable by the decision-making entity 318 and can update the dimensionality through the visualization helper 430.

Based on the queries selected in the query selector, the visualizations can also be updated. The visualization view 312 can include clusters 503 of entities 501 clustered based on determined similarity of properties of the entities 501. The entities 503 can correspond to the candidate polymers that are being processed. This can uncover some clusters 501 that can reveal a new subset of the data the decision-making entity 318 was previously unaware of. For example, a decision-making entity (e.g. material scientist) can look for a new material with high tensile strength but low melting point and soluble in water. The predictions of the VLLM given the components of each compound for these properties, once visualized, would let the scientist see the possible tradeoffs and choose one meeting the needs of his use case.

The decision-making entity 318 can create a visualization view 312 based on the answer to a couple of questions. They have assigned the answer for “What is the molecular weight of the polymer sample?" to the X axis and also assigned visual attributes to the answers to a few questions. From this visualization view 312, it is easy to see that there are several clusters 503 in the data, which enables easier way to pick out the polymer sample visually that has the highest molecular weight, that is also likely to be biodegradable and that is also based on an input polymer example.

For network monitoring, the clusters can represent normal metric data and abnormal data. The entities can represent the metric data from a network system. For example, cluster for entity D can be identified as a normal request from a user within a second. Cluster for entities K,L,M,N,O can represent an abnormal request from a user within a second. As such, the cluster for entities K,L,M,N,O can be identified and corrective action 311 can be generated for issues resulting from such cluster such as blocking IP packets from the IP corresponding to the cluster.

For vehicle control, the clusters can represent driving behaviors and the entities can represent entities within a traffic scene. Based on user queries, the visualization view 312 can be updated. The visualization view 312 can then be utilized by the decision-making entity 318 to control the vehicle.

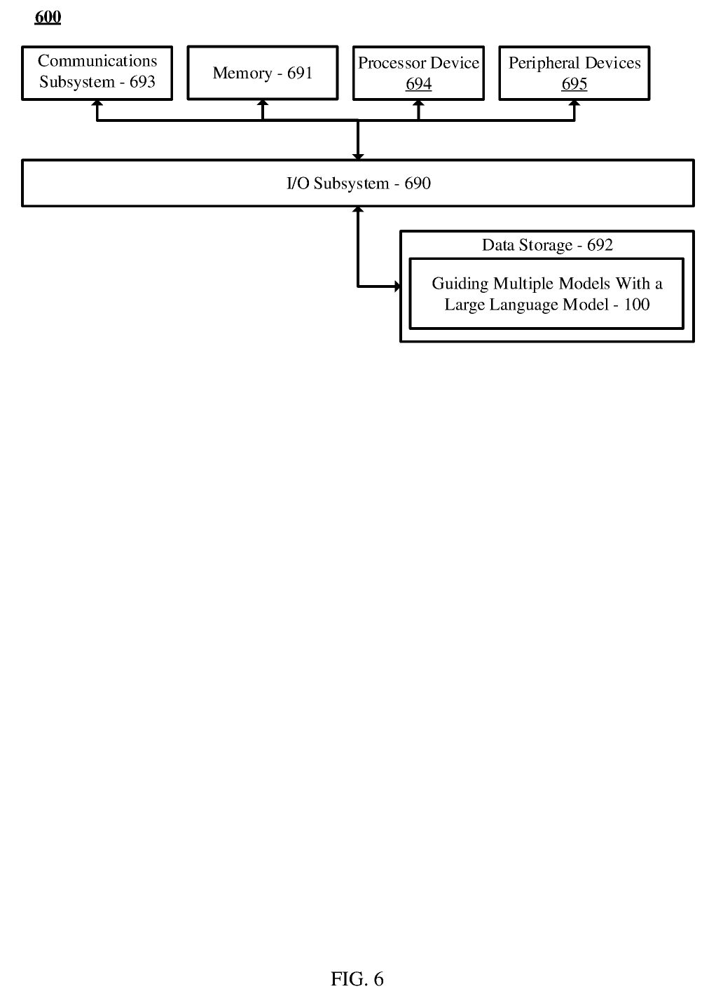

Referring now to FIG. 6, a block diagram showing a computer system for guiding multiple models with a large language model, in accordance with an embodiment of the present invention.

The computing device 600 illustratively includes the processor device 694, an input/output (I/O) subsystem 690, a memory 691, a data storage device 692, and a communication subsystem 693, and/or other components and devices commonly found in a server or similar computing device. The computing device 600 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 691, or portions thereof, may be incorporated in the processor device 694 in some embodiments.

The processor device 694 may be embodied as any type of processor capable of performing the functions described herein. The processor device 694 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 691 may be embodied as any type of volatile or non-volatile memory or data storage capable of performing the functions described herein. In operation, the memory 691 may store various data and software employed during operation of the computing device 600, such as operating systems, applications, programs, libraries, and drivers. The memory 691 is communicatively coupled to the processor device 694 via the I/O subsystem 690, which may be embodied as circuitry and/or components to facilitate input/output operations with the processor device 694, the memory 691, and other components of the computing device 600. For example, the I/O subsystem 690 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 690 may form a portion of a system-on-a-chip (SOC) and be incorporated, along with the processor device 694, the memory 691, and other components of the computing device 600, on a single integrated circuit chip.

The data storage device 692 may be embodied as any type of device or devices configured for short-term or long-term storage of data such as, for example, memory devices and circuits, memory cards, hard disk drives, solid state drives, or other data storage devices. The data storage device 692 can store program code for guiding multiple models with a large language model 100. Any or all of these program code blocks may be included in a given computing system.

The communication subsystem 693 of the computing device 600 may be embodied as any network interface controller or other communication circuit, device, or collection thereof, capable of enabling communications between the computing device 600 and other remote devices over a network. The communication subsystem 693 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 600 may also include one or more peripheral devices 695. The peripheral devices 695 may include any number of additional input/output devices, interface devices, and/or other peripheral devices. For example, in some embodiments, the peripheral devices 695 may include a display, touch screen, graphics circuitry, keyboard, mouse, speaker system, microphone, network interface, and/or other input/output devices, interface devices, GPS, camera, and/or other peripheral devices.

Of course, the computing device 600 may also include other elements (not shown), as readily contemplated by one of skill in the art, as well as omit certain elements. For example, various other sensors, input devices, and/or output devices can be included in computing device 600, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 600 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result. In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

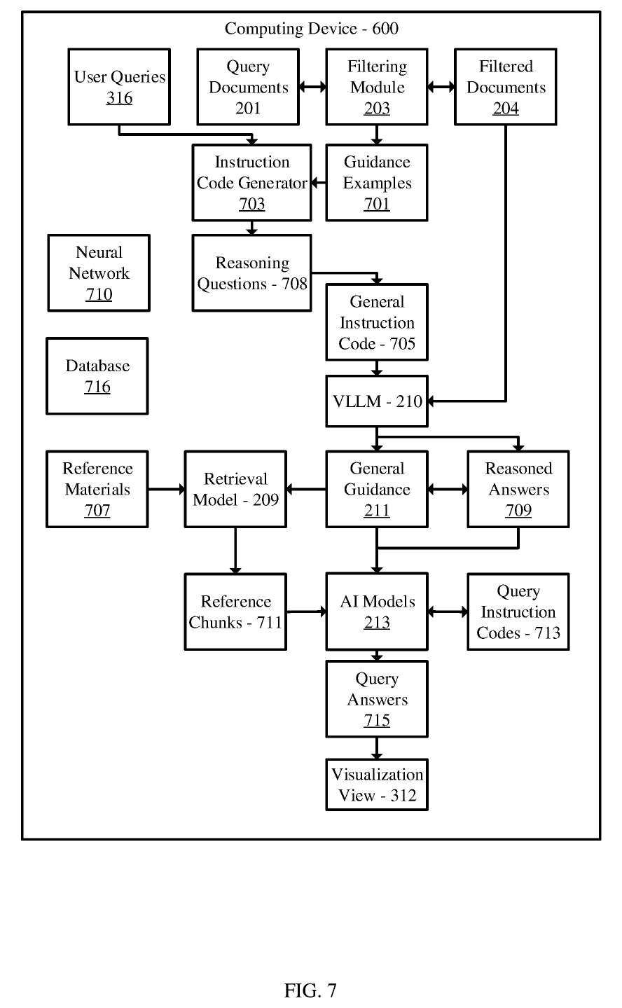

Referring now to FIG. 7, a block diagram showing hardware and software components of the computing device that implements guiding multiple models with a large language model, in accordance with an embodiment of the present invention.

In an embodiment, during the processing of computing device 600, user queries 316 and filtered documents 204 can be processed by the VLLM 210 to generate general guidance 211 based on a general instruction code 705. The general instruction code 705 can be generated by an instruction code generator 703 by utilizing guidance examples 701, reasoning questions 708, and user queries 316. The guidance examples 701 can be generated by the filtering module 203 from filtered documents 204 processed from query documents 201. The general instruction code 705 can be updated to generate reasoned answers 709 to answer reasoning questions 708 from reference chunks 711. The reference chunks 711 can be extracted by the retrieval model 209 from reference materials 707 based on the general guidance. The reasoning questions 708 can be generated by the instruction code generator 703.

The general guidance 211 can be derived from query instruction codes 713, reference chunks 711, user queries 316 and reasoned answers 709. The general guidance 211 can be sent to the AI models 213 to generate query answers 715. The query answers 715 can be utilized to perform downstream tasks 340 and visualized through visualization view 312. The processing data including the query answers 715, general guidance 211, guiding examples 701, query documents 201, user queries 316, general guidance 211, query instruction codes 713, query answers 715, etc. can be saved in a database 716. The processing data can be utilized by a neural network 710 to learn the relationships between the processing data and to generate instruction codes, extract reference chunks, filter query documents, etc. The filtering module 203, instruction code generate code generator, retrieval model, AI models 213 can utilize the neural network 710. In an embodiment the neural network 710 can be trained to perform the processes stated herein (e.g., prompt engineering, domain-specific knowledge, etc.).

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example’s input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The neural network, such as a multilayer perceptron, can have an input layer of source neurons, one or more computation layer(s) having one or more computation neurons, and an output layer, where there is a single output neuron for each possible category into which the input example could be classified. An input layer can have a number of source neurons equal to the number of data values in the input data. The computation neurons in the computation layer(s) can also be referred to as hidden layers, because they are between the source neurons and output neuron(s) and are not directly observed. Each neuron in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, … w_{n-1,} wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

Training a deep neural network can involve two phases, a forward phase where the weights of each neuron are fixed and the input propagates through the network, and a backwards phase where an error value is propagated backwards through the network and weight values are updated. The computation neurons in the one or more computation (hidden) layer(s) perform a nonlinear transformation on the input data that generates a feature space. The classes or categories may be more easily separated in the feature space than in the original data space.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method, comprising:
generating an instruction code for a very large language model (VLLM) to generate a general guidance to guide AI models that answer reasoning questions for query documents;
updating the instruction code with domain-specific information from reference materials to generate, with the VLLM, a reasoned answer for reasoning questions about the query documents generated based on the general guidance;
processing the reasoned answers into the general guidance with the VLLM; and
answering, with the AI models, the reasoning question iteratively applied to the query documents using the general guidance to perform downstream tasks.

2. The computer-implemented method of claim 1, wherein generating the instruction code further comprises providing filtered query documents to the VLLM to ensure privacy of the query documents.

3. The computer-implemented method of claim 2, wherein generating the instruction code further comprises extracting guidance examples from filtered query documents to instruct the VLLM.

4. The computer-implemented method of claim 3, wherein generating the instruction code further comprises concatenating extracted text from the guidance examples to the instruction code.

5. The computer-implemented method of claim 1, wherein updating the instruction code further comprises extracting reference chunks from reference materials based on the general guidance.

6. The computer-implemented method of claim 5, wherein updating the instruction code further comprises appending the reference chunks to the instruction code to generate reasoning questions.

7. The computer-implemented method of claim 6, wherein updating the instruction code further comprises determining reasoned answers based on the reasoning questions by utilizing the VLLM.

8. The computer-implemented method of claim 1, wherein the downstream tasks further comprises manufacturing a polymer using candidate materials determined to have desired properties.

9. The computer-implemented method of claim 8, wherein manufacturing the polymer further comprises visualizing clusters of candidate materials based on determined similarity of properties.

10. A system, comprising:
a memory device;
one or more processor devices operatively coupled with the memory device to perform operations:
generating an instruction code for a very large language model (VLLM) to generate a general guidance to guide AI models that answer reasoning questions for query documents;
updating the instruction code with domain-specific information from reference materials to generate, with the VLLM, a reasoned answer for reasoning questions about the query documents generated based on the general guidance;
processing the reasoned answers into the general guidance with the VLLM; and
answering, with the AI models, the reasoning question iteratively applied to the query documents using the general guidance to perform downstream tasks.

11. The system of claim 10, wherein generating the instruction code further comprises providing filtered query documents to the VLLM to ensure privacy of the query documents.

12. The system of claim 11, wherein generating the instruction code further comprises extracting guidance examples from filtered query documents to instruct the VLLM.

13. The system of claim 12, wherein generating the instruction code further comprises concatenating extracted text from the guidance examples to the instruction code.

14. The system of claim 10, wherein updating the instruction code further comprises extracting reference chunks from reference materials based on the general guidance.

15. The system of claim 14, wherein updating the instruction code further comprises appending the reference chunks to the instruction code to generate reasoning questions.

16. The system of claim 15, wherein updating the instruction code further comprises determining reasoned answers based on the reasoning questions by utilizing the VLLM.

17. The system of claim 10, wherein the downstream tasks further comprises manufacturing a polymer using candidate materials determined to have desired properties.

18. The system of claim 17, wherein manufacturing the polymer further comprises visualizing clusters of candidate materials based on determined similarity of properties.

19. A non-transitory computer program product comprising a computer- readable storage medium including a program code, wherein the program code when executed on a computer causes the computer to perform operations including:
generating an instruction code for a very large language model (VLLM) to generate a general guidance to guide AI models that answer reasoning questions for query documents;
updating the instruction code with domain-specific information from reference materials to generate, with the VLLM, a reasoned answer for reasoning questions about the query documents generated based on the general guidance;
processing the reasoned answers into the general guidance with the VLLM; and
answering, with the AI models, the reasoning question iteratively applied to the query documents using the general guidance to perform downstream tasks.

20. The non-transitory computer program of claim 19, wherein the downstream tasks further comprises manufacturing a polymer using candidate materials determined to have desired properties.
